(19) United States
(12) Patent Application Publication
(10) Pub. No.: US 2025/0048965 A1
(43) Pub. Date: Feb. 13, 2025

(54) SELF-PROPELLED COMBINE HARVESTER AND METHOD FOR OPERATING A SELF-PROPELLED COMBINE HARVESTER

(71) Applicant: CLAAS Selbstfahrende Erntemaschinen GmbH, Harsewinkel (DE)

(72) Inventors: Christian Füchtling, Rinkerode (DE); Andreas Wielenberg, Herford (DE); Thomas Hinz, Harsewinkel (DE)

(73) Assignee: CLAAS Selbstfahrende Erntemaschinen GmbH, Harsewinkel (DE)

(21) Appl. No.: 18/797,772

(22) Filed: Aug. 8, 2024

(30) Foreign Application Priority Data
Aug. 8, 2023 (DE) 102023121095.5

(51) Int. Cl. A01D 41/14

(52) U.S. Cl. CPC A01D 41/145; A01D 41/141

(57) ABSTRACT

A self-propelled combine harvester and a method for operating a self-propelled combine harvester. The self-propelled combine harvester comprises a feed channel which is pivotably articulated to a combine harvester about a horizontal axis for height adjustment by linear actuators, and a draper arranged or positioned on the feed channel, which comprises a center segment with a central frame segment and two side segments each with an outer frame segment. The particular side segment is pivotably connected to the center segment by a frame joint comprising a pivot axis, and the particular side segment is positionable relative to the center segment by an actuatable actuator. The combine harvester includes a control unit that is configured to actuate the actuators in order to align the side segments relative to the center segment depending on the height adjustment of the feed channel when lifting the draper.

### CROSS REFERENCE TO RELATED APPLICATION

This application claims priority under 35 U.S.C. § 119 to German Patent Application No. DE 10 2023 121 095.5 filed Aug. 8, 2023, the entire disclosure of which is hereby incorporated by reference herein.

### TECHNICAL FIELD

The present invention relates to a self-propelled combine harvester and a method for operating a self-propelled combine harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 3 420 799 A1 discloses a self-propelled combine harvester with a multi-part draper. The multi-part design of the drapers with side segments pivotable relative to the center segment enables wider harvesting headers to follow the ground contour more precisely during harvesting and therefore cut off more harvested material. When a headland is reached, the draper is lifted out, wherein the side segments are generally moved to a center position in which the side segments enclose an angle of approximately 180° relative to the center segment (i.e. the side segments and the center segment are essentially oriented lying in a horizontal plane).

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a frontal view of a combine harvester with a draper arranged or positioned thereon.

FIG. 2 illustrates a schematic view of the draper.

FIG. 3 illustrates a partial view of the draper according to FIG. 2 from the rear.

FIG. 4A schematically illustrates a center position of the draper.

FIG. 4B schematically illustrates a deflected position of the draper.

FIG. 5 illustrates a schematic and exemplary partial representation of an operating display of the combine harvester.

### DETAILED DESCRIPTION

As discussed in the background, drapers with side segments may be pivotable relative to the center segment, thereby enabling wider harvesting headers to follow the ground contour more precisely during harvesting and therefore cut off more harvested material. In very hilly conditions, it may however, occur that there is not enough ground clearance. This may be particularly problematic for drapers with a large working width. In such situations, it may be helpful to use the flexible adaptability of the multi-part draper to avoid placement on the field soil. Manual control of the draper for lifting is usually achieved by actuating a switch on a multifunctional handle, wherein the side segments are brought into the center position. However, manual activation of the side segments to swing out beyond the center position may require great attention on the part of the operator and must be accomplished with an additional interaction of the operator with an operating unit of a control unit serving to activate the draper. To continue the harvesting process after driving through the headland, the operator must interact again with the control unit in order to reset the setting deviating from normal operation. If this is omitted, the side segments are swung upwards unnecessarily far relative to the center segment. Swinging the side segments out unnecessarily far may result in additional wear on the cutter bar.

Thus, in one or some embodiments, a self-propelled combine harvester and a method for operating a self-propelled combine harvester are disclosed, whereby simpler and more intuitive handling is achieved in the manual control for lifting the side segments.

In particular, in one or some embodiments, a self-propelled combine harvester is disclosed that comprises a feed channel which is pivotably articulated about a horizontal axis for height adjustment by at least one device (such as one or more linear actuators), and a draper arranged or positioned on the feed channel, which may comprise a center segment with a central frame segment and at least two side segments (such as only two side segments), each with an outer frame segment. Further, the particular or respective side segment may be pivotably connected to the center segment by a frame joint comprising a pivot axis, and with the particular side segment being positionable relative to the center segment by one or more actuatable actuators. The combine harvester may further comprise a control unit that is configured to actuate (such as automatically actuate) the one or more actuators in order to align the side segments relative to the center segment depending on the height adjustment of the feed channel when lifting the draper (e.g., automatically determine a height adjustment of the feed channel when lifting the draper; and automatically actuate the one or more actuators in order to align the side segments relative to the center segment depending on the height adjustment of the feed channel when lifting the draper).

This is based on the idea of simplifying handling during manually controlled lifting of the draper unit and making it more intuitive by aligning the side segments relative to the center segment during actuation of only one operating element with which the height of the feed channel is changed. The relative alignment may depend on the current height of the feed channel. Therefore swinging out beyond a central position may be performed simply by actuating the single operating element without interruption.

In one or some embodiments, at least one sensor may be used for this purpose, with the at least one sensor: generating signal(s) indicative of a pivot angle of the feed channel; and transmitting the signal(s) to the control unit. In turn, the control unit may evaluate the signal(s) received from the at least one sensor in order to automatically determine the height adjustment of the feed channel. Various sensors are contemplated. As one example, the sensor may comprise a rotary potentiometer. As the at least one sensor, the rotary potentiometer may, for example, be arranged or positioned on the axle about which the feed channel may be pivoted for height adjustment.

In turn, based on the automatic determination of the control unit of the determined height adjustment, the control unit may control one or more actuators depending on a threshold value for the pivot angle, which may be saved in the control unit, in order to transfer the side segments into a deflected position in which the side segments are swiveled up at a predetermined angle (e.g., a maximum assumable angle) relative to the center segment. When manually lifting the draper, the operator may therefore specify whether an exceeding of the threshold value occurs in order to transfer the outer ends of the side segments into a position at a maximum distance from the ground. This may also be necessary in particular if, for example, lateral obstacles must be passed when entering or leaving a field with a mounted draper. When manually lifting the draper, the operator may specify a deflection of the side segments with a value for the angle that is below the value for the angle (which may be below the value for the arising angle that arises at the position of the side segments) at the maximum distance from the ground after the threshold value has been exceeded by interrupting the process of manual lifting. This may also allow for a smaller deflection of the side segments to be set.

In particular, a sensor arrangement (e.g., at least one sensor and structure to communicate signals to the control unit, such as wiring and/or wireless transceiver) may be arranged or positioned on each of the frame joints to monitor the angle arising between the center segment and the side segments. This may make it possible to display the currently arising angle to the operator during the process of manual lifting by evaluating, through the control unit, sensor signals from the sensor arrangements. In one or some embodiments, the sensor arrangements may be comprise rotary potentiometers.

Furthermore, the control unit may be configured to actuate the actuator(s) depending on the height adjustment of the feed channel only when there is an indication of a manually-initiated lifting of the draper (e.g., only responsive to the control unit determining that there is a manually initiated lifting of the draper that has been manually input by the operator, the control unit may send one or more commands to the actuator(s) based on the height adjustment of the feed channel).

In one or some embodiments, the control unit may be operated in an automatic mode (e.g., responsive to receiving an indication to operate in the automatic mode) in which a first and a second target value for the pivot angle may be preset in order to automatically align the side segments relative to the center segment depending on these target values during the lifting of the draper. The operator of the combine harvester may specify or set the two target values for the pivot angle that lie below the threshold value in order to be relieved of manually controlling the distance of the draper to the ground when driving in the field and of manually controlling the lifting of the draper when driving through a headland. In this regard, the operator may provide manual input prior to driving in the field and/or prior to driving through the headland in order to perform the automatic operation in real time (e.g., when driving in the field and/or when driving through a headland). The automatic mode may be activated by the operator and, responsive to the automatic mode being activated by the operator (e.g., receiving an indication of the automatic mode), executed by the control unit, for example, depending on signals from a route planning module upon detecting that a headland is reached. When a headland is reached, the draper in automatic mode may be moved to its center position in accordance with the second target value, which may be greater than the first target value, in which, in one or some embodiments, the side segments and the center segment may be essentially at the same height.

Furthermore, the control unit may be configured to override the automatic mode when lifting the draper by means of a manual input via an operating unit. If the operator of the combine harvester recognizes a situation in which the automatic lifting of the draper and the associated swinging out of the side segments into the middle position is not sufficient to avoid a collision of one or both side segments with the ground or another obstacle in the outer edge areas of the side segments, he/she may override the automatic lifting of the draper (e.g., input a manual indication). For this purpose, an operating element that is part of the operating unit may be used to control at least one device, such as the linear actuators, for height adjustment of the feed channel. And, for this purpose, the operating element, with which the height adjustment of the feed channel may be manually controlled, may be actuated (such as permanently actuated) until the threshold value saved in the control unit for the pivot angle is exceeded. The control unit may comprise a multifunctional handle that has a plurality operating elements. The multifunctional handle may be located on an armrest on the driver's seat and may enable ergonomic operation of the combine harvester and the draper without changing the sitting position of the operator or by reaching around.

In one or some embodiments, the actuators may comprise hydraulic cylinders. Furthermore, the actuators designed as hydraulic cylinders may be connected to a pressure accumulator so that they may be used as hydraulic springs.

In one or some embodiments, a method for operating a self-propelled combine harvester is disclosed, comprising a feed channel which is pivoted about a horizontal axis by one or more actuators (such as linear actuators) for height adjustment, and a draper arranged or positioned on the feed channel, which has a center segment with a central frame segment and at least two side segments, each with an outer frame segment. A respective or particular side segment may be pivotably connected to the center segment by a frame joint comprising a pivot axis, with the respective side segment being positioned relative to the center segment by a controllable actuator. Moreover, the combine harvester may be controlled by a control unit by which the actuator(s) are controlled in order to align the side segments relative to the center segment depending on the height adjustment of the feed channel upon raising the draper.

In particular, at least one sensor may generate signal(s) for a pivot angle of the feed channel and may transmit the signal(s) to the control unit. In turn, the control unit may evaluate the signal(s) to determine the height adjustment of the feed channel.

Furthermore, depending on a threshold value for the pivot angle, which may be saved in the control unit, the side segments may be transferred or moved into a deflected position in which the side segments are swiveled up at a predetermined angle, such as a maximum assumable angle, relative to the center segment. The outer ends of the side segments may be transferred or moved to a position projecting above the center segment. By interrupting the manual lifting process, the operator may specify a deflection of the side segments with a value for the angle that is below the value for the angle that is set in the position of the side segments at the maximum distance from the ground when the draper is lifted manually after the threshold value has been exceeded. This may also allow for a smaller deflection of the side segments to be set.

Furthermore, in one or some embodiments, the actuation of the actuators may be undertaken depending on the height adjustment of the feed channel only when there is manually initiated lifting of the draper. An active automatic mode may be overridden by the manually triggered lifting of the draper. For this purpose, the operator of the combine harvester may actuate (such as continuously actuate) the operating element provided for the height adjustment until the current pivot angle of the feed channel exceeds the threshold value saved in the control unit for this purpose.

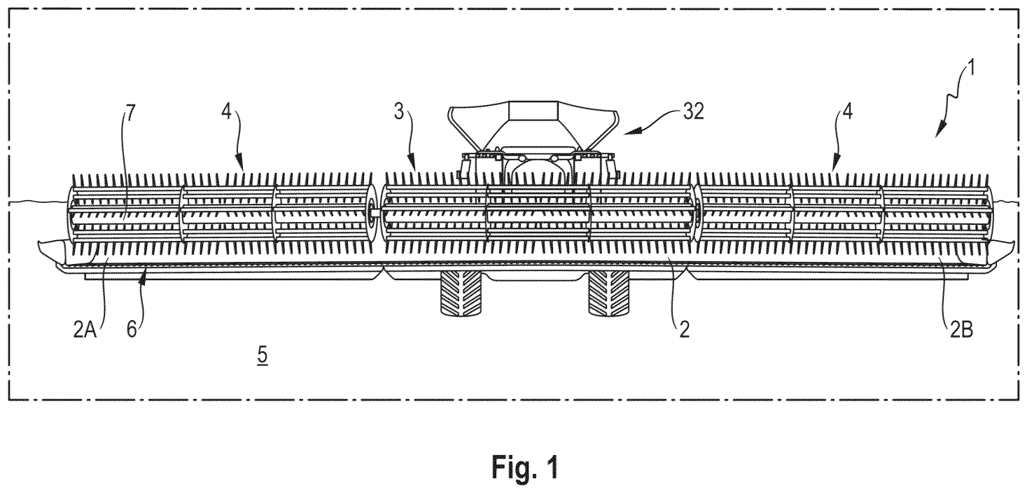

Referring to the figures, FIG. 1 shows a frontal view of a combine harvester 32 with a draper 1 arranged or positioned thereon. Examples of combine harvesters are disclosed in U.S. Pat. No. 6,544,118 B2, US Patent Application Publication No. 2018/0168101 A1, US Patent Application Publication No. 2023/0397533 A1 and US Patent Application Publication No. 2024/0196796 A1, each of which is incorporated by reference herein in its entirety. Examples of drapers include US Patent Application Publication No. 2024/0008410 A1, incorporated by reference herein in its entirety. The draper 1 is in a position raised through a feed channel 12 of the combine harvester 32 (e.g., at a distance from the floor 5). For height adjustment, the feed channel 12 may be articulated to the combine harvester 32 by actuator(s), such as linear actuators 33, so that the feed channel 12 may pivot about a horizontally running axis 13. In one or some embodiments, linear actuators 33 may comprise hydraulic actuators configured, responsive to a command from control unit 20, to provide a mechanical force, such as a hydraulic force, to pivot the feed channel 12.

In one or some embodiments, the draper 1 has a segmented frame. The draper 1 may have a center segment 3 with a central frame segment 2 and two side segments 4, each with an outer frame segment 2A, 2B. The side segments 4 may be arranged or positioned adjacent to the center segment 3. A ground-copying cutterbar 6 may be arranged or positioned on the center segment 3 and the side segments 4 on the front side of the draper 1 opposite the segmented frame, which may extend substantially over the entire width of the draper 1. Furthermore, a reel 7 with a segmented design may be provided and which may extend substantially across the entire width of the draper 1.

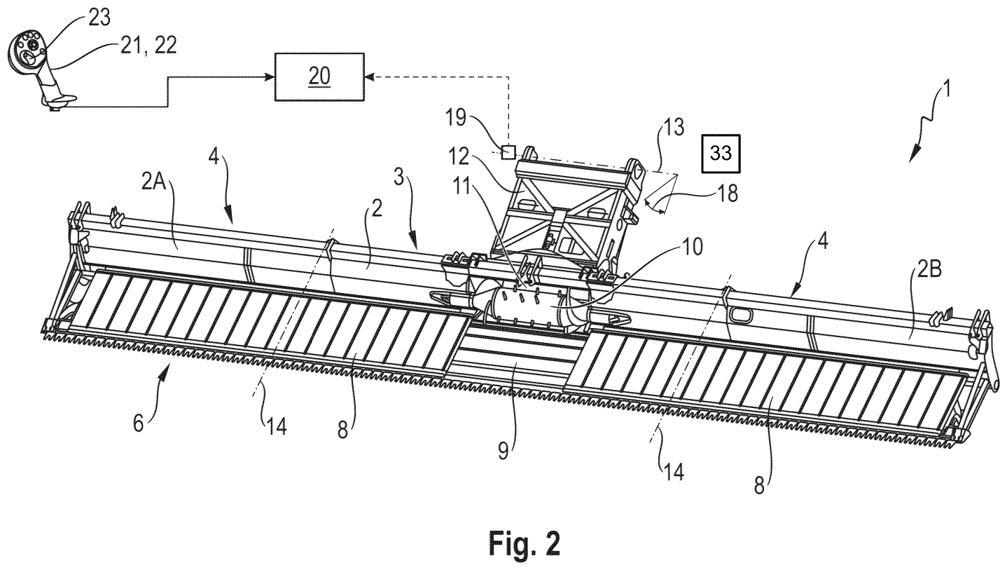

The illustration in FIG. 2 shows a schematic view of the draper 1. Harvested material cut off by the cutterbar 6 may be fed to a conveyor device arranged or positioned behind the cutterbar 6, which may be designed as an endlessly circulating conveyor belt 8 on the respective side segments 4. The endlessly circulating conveyor belts 8 may be arranged or positioned adjacent to the center segment 3 in order to transport harvested material cut off by the cutterbar 6 sideways (e.g., transversely to the direction of travel of the combine harvester 32) in the direction of the center segment 3 and to feed it to a feed device of the draper 1, which may be designed as a driven feed roller 10. The center segment 3 may also comprise an endlessly circulating conveyor belt 9. The conveyor belt 9 of the center segment 3 may convey transversely to the conveying direction of the laterally conveying conveyor belts 8 of the side segments 4. The feed roller 10 may feed the harvested material fed laterally to the center segment 3 by the endlessly circulating conveyor belts 8 or 9 to an opening 11 provided in the central frame segment 2 and located behind the feed roller 10. Through the opening 11, the picked up or collected harvested material may be fed to the combine harvester 32 for further processing through the feed channel 12 arranged or positioned on the combine harvester 32, to which the draper 1 may be detachably attached. A conveyor device may be arranged or positioned in the feed channel 12, which may accept the harvested material supplied by the feed roller 10 and may convey the harvested material into the combine harvester 32 for further processing.

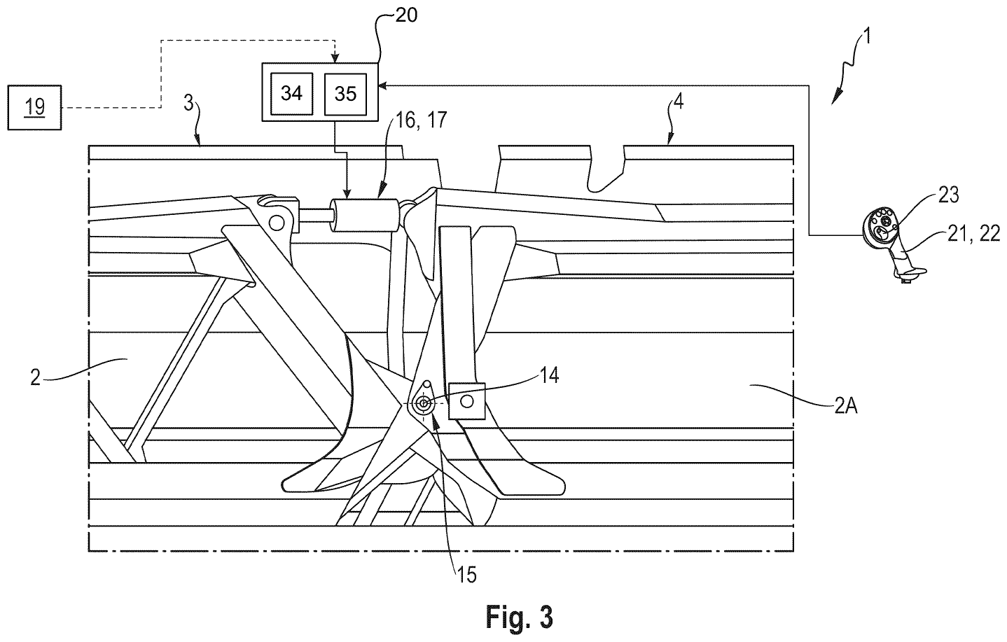

FIG. 3 shows a partial view of the draper 1 according to FIG. 2 from the rear. The particular side segment 4 may be pivotably connected to the center segment 3 by a frame joint 15 comprising a pivot axis 14. The particular side segment 4 may be positioned by a controllable actuator 16 by pivoting about the pivot axis 14 relative to the center segment 3. The actuator 16 may comprise a double-acting hydraulic cylinder 17. Other actuators are contemplated.

In one or some embodiments, the combine harvester 32 comprises a control unit 20, which is configured to control the various devices disclosed herein, including the linear actuators 33 for adjusting the height of the feed channel 12 and/or the actuators 16 on the draper 1. The control unit 20 comprises at least one processor 34 and at least one memory 35, which may be in communication with one another. In one or some embodiments, the processor 34 may comprise a microprocessor, controller, PLA, or the like. Similarly, the memory 35 may comprise any type of storage device (e.g., any type of memory). Though the processor 34 and the memory 35 are depicted as separate elements, they may be part of a single machine, which includes a microprocessor (or other type of controller) and a memory. Alternatively, the processor 34 may rely on the memory 35 for all of its memory needs. The memory 35 may comprise a tangible computer-readable medium that include software that, when executed by the processor 34 is configured to perform any one, any combination, or all of the functionality described herein regarding any computing device.

The processor 34 and the memory 35 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, at least one sensor 19 is provided on, attached to, or sensing at least one aspect of the feed channel, with the at least one sensor 19 configured to generate one or more signals indicative of a pivot angle 18 of the feed channel 12 and to transmit the one or more signals to the control unit 20. In turn, the control unit 20 is configured to automatically evaluate the one or more signals received from the at least one sensor 19 to determine the height adjustment of the feed channel 12.

Furthermore, in one or some embodiments, the control unit 20 is operationally connected to (e.g., in wired and/or wireless communication with) an operating unit 21 arranged or positioned in the cab of the combine harvester 32. In one or some embodiments, the operating unit 21 comprises a multifunctional handle 22, which may include a plurality of operating elements 23 (e.g., control elements). One of the operating elements 23 may server for manual height adjustment of the feed channel 12. The feed channel 12 may be raised or lowered by continuous manual actuation of the operating element 23. In practice, movement or activation of the one or more operating elements 23 of the multifunctional handle 22 may send one or more signals to the control unit 20. In turn, interpreting the signals from the multifunctional handle 22, the control unit 20 may automatically generate one or more commands to control the feed channel 12 (e.g., send commands to one or more actuators to raise and/or lower the feed channel 12 based on manual input as indicated by the operating elements 23). Other configurations of the operating unit 21 are contemplated, such as a touchscreen or the like in which manual input may be entered of manual height adjustment of the feed channel 12. In one or some embodiments, the multifunctional handle may be located on an armrest on the driver's seat and enables ergonomic operation of the combine harvester 32 and the draper 1 without changing the sitting position of the operator or by reaching around.

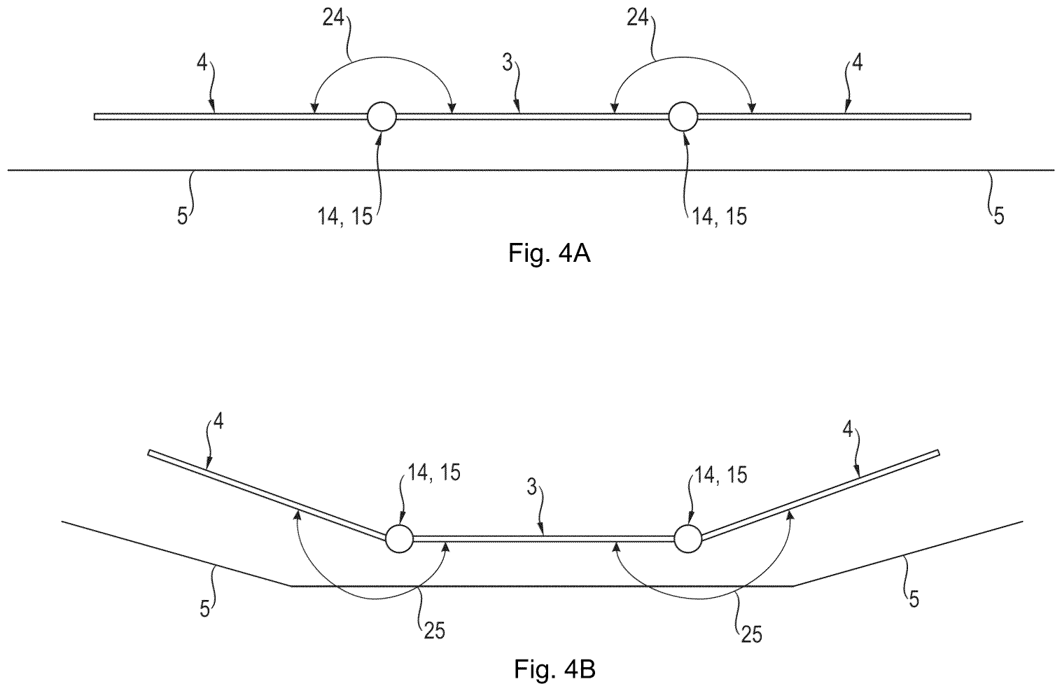

FIG. 4A schematically illustrates a center position of the draper 1, and FIG. 4B schematically illustrates an upward deflected position of the draper 1. In the center position of the draper 1 depicted in FIG. 4A, the side segments 4 and the center segment 3 have an orientation lying basically in a horizontal plane. An angle 24 of approximately 180° is enclosed between the respective side segment 4 and the center segment 3 on the upper side facing away from the floor 5 (e.g., ground).

Upon reaching a headland, the draper 1 may be lifted by controlling the linear actuators on the feed channel 12, wherein the side segments 4 may be generally transferred to the center position shown in FIG. 4A, in which the angle 24 is enclosed between the particular side segment 4 and the center segment 3.

Due to the working width of the draper 1, situations may arise in which the transfer of the raised draper 1 to the center position is not sufficient to drive through a headland, for example, without collision with the side segments 4 located in the center position. Other situations in which the center position may be insufficient may be the relocation or changing of the field of the combine harvester 32.

FIG. 4B illustrates the deflected position of the draper 1. In one or some embodiments, the control unit 20 is configured to automatically control the actuators 16 depending on a threshold value 31 for the pivot angle 18, which is saved or may be saved in the control unit 20, in order to transfer the side segments 4 into a deflected position in which the side segments 4 are swiveled up at a predetermined angle 25, such as at a maximum assumable angle, relative to the center segment 3. In one or some embodiments, the predetermined angle 25 that the side segments 4 and the center segment 3 enclose on their underside facing the floor 5 is greater than 180°. In particular, the control unit 20 may be configured to automatically actuate the actuators 16 depending on the height adjustment of the feed channel 12 only when there is manually-initiated lifting of the draper 1. In this regard, in one or some embodiments, the control unit 20 may automatically determine both: (i) whether there is a manually-initiated lifting of the draper 1 (e.g., via the operating unit 21); and (ii) based on the height adjustment of the feed channel 12.

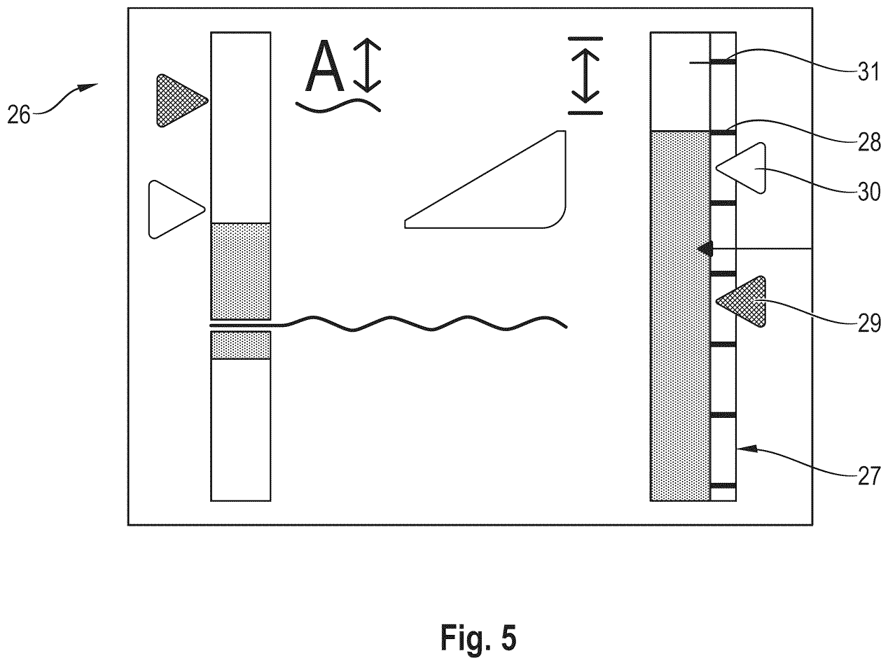

FIG. 5 illustrates a schematic partial representation of an operating display 26 of the combine harvester 32. In one or some embodiments, the operating display 26 comprises a touchscreen. A current position based on the set pivot angle 18 of the feed channel 12 is illustrated as an actual value 28 via a scale 27. The control unit 20 may be operated in an automatic mode in which a first target value 29 and a second target value 30 for the pivot angle 18 are preset or may be preset in order to automatically align the side segments 4 relative to the center segment 3 depending on these target values 29, 30 during the lifting of the draper 1. In this regard, the operator may indicate the desire to enter the automatic mode via input on the operating display 26.

In one or some embodiments, the adjustable first target value 29 specifies the position of the draper 1 and/or the pivot angle 18 of the feed channel 12 to be set when the harvested material is to be picked up by the draper 1 (e.g., corresponding to a first operation (such as a first automatic operation) of the combine harvester indicating a situation that does not necessitate to transfer the draper 1 to the deflected position). The adjustable second target value 30, which is greater than the first target value 29, specifies the position of the draper 1 or the pivot angle 18 of the feed channel 12 if the draper 1 is to be lifted automatically upon reaching and/or driving a headland in automatic mode (e.g., corresponding to a second operation (such as a second automatic operation) of the combine harvester indicating a situation that does necessitate to transfer the draper 1 to the deflected position).

In a situation in which the operator recognizes that the transfer of the side segments 4 to their central position when lifting the draper 1 in automatic mode, as shown in FIG. 4A, is not sufficient to compensate for an obstacle or unevenness of the floor 5 in the outer edge regions of one side segment 4 or both side segments 4, the operator may override the automatic mode by actuating (such as permanently actuating) the operating element 23 (e.g., the operator may push one or more of the buttons on operating element 23).

To accomplish this, responsive to the control unit 20 automatically identifying the actuation of the operating element 23, the control unit 20 automatically controls the actuators depending on a threshold value 31 for the pivot angle 18, which is saved or may be saved in the control unit 20, in order to automatically transfer the side segments 4 into a deflected position in which the side segments 4 are swiveled up at an angle 25 at a maximum assumable angle, relative to the center segment 3, as shown in FIG. 4B.

During the process of manually lifting the draper 1 after the threshold value 31 has been exceeded, a deflection of the side segments 4 with a value for the angle 25 that is below the value for the maximum angle 25 that may be assumed, which is set in the position of the side segments 4 at the maximum distance from the floor 5, may be specified by interrupting the process (e.g., automatically interrupting the manually-initiated lifting of the draper). Once the threshold value 31 is automatically determined by the control unit 20 to be exceeded during manually-initiated lifting, the deflection of the side segments 4 may be automatically started. By interrupting (e.g., stopping) the process of manually-initiated lifting the draper 1, the angle 25 by which the side segments 4 are swung up relative to the center segment 3 may be adjusted (such as automatically adjusted).

In this regard, a sensor arrangement may be arranged or positioned on each of the frame joints 15 to monitor the angle 25 arising between the center segment 3 and the side segments 4. In one or some embodiments, sensor signals generated by the sensor arrangements may be evaluated by the control unit 20 in order to display the currently adjusting angle 25 to the operator during the process of manual lifting (e.g., on operating display 26). In one or some embodiments, the sensor arrangements may be designed as rotary potentiometers.

The control unit 20 may be configured to actuate the actuators 16 depending on the height adjustment of the feed channel 12 only when there is manually-initiated lifting of the draper 1. If the control unit 20 identifies that the threshold value 31 for the pivot angle 18 is passed and identifies simultaneous manual actuation, the control unit 20 may temporarily override the automatic mode in order to move the side segments 4 into their predetermined upwardly-deflected position, such as their maximum upwardly-deflected position.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Draper |
| 2 | Central frame segment |
| 2A | Outer frame segment |
| 2B | Outer frame segment |
| 3 | Center segment |
| 4 | Side segment |
| 5 | Ground |
| 6 | Cutter bar |
| 7 | Reel |
| 8 | Conveyor belt |
| 9 | Conveyor belt |
| 10 | Feed roller |
| 11 | opening |
| 12 | Feed channel |
| 13 | Axis |
| 14 | Pivot axis |
| 15 | Frame joint |
| 16 | Actuator |
| 17 | Hydraulic cylinder |
| 18 | Swiveling angle |
| 19 | Sensor |
| 20 | Control unit |
| 21 | Operating unit |
| 22 | Multifunctional handle |
| 23 | Operating element |
| 24 | Angle |
| 25 | Angle |
| 26 | Operating display |
| 27 | Scale |
| 28 | Actual value |
| 29 | First target value |
| 30 | Second target value |
| 31 | Threshold value |
| 32 | Combine harvester |
| 33 | Linear actuators |
| 34 | Processor |
| 35 | Memory |

1. A self-propelled combine harvester comprising:
a feed channel which is pivotably articulated to the combine harvester about a horizontal axis for height adjustment by at least one device;
a draper positioned on the feed channel and including a center segment with a central frame segment and at least two side segments, each with an outer frame segment, wherein a respective side segment is pivotably connected to the center segment by a frame joint comprising a pivot axis, wherein the respective side segment is positionable relative to the center segment by one or more actuators; and
a control unit configured to:
automatically determine a height adjustment of the feed channel when lifting the draper; and
automatically actuate the one or more actuators in order to align the at least two side segments relative to the center segment depending on the height adjustment of the feed channel when lifting the draper.

2. The combine harvester of claim 1, further comprising at least one sensor configured to generate one or more signals indicative of a pivot angle of the feed channel and to transmit the one or more signals to the control unit; and
wherein the control unit is configured to evaluate the one or more signals received from the at least one sensor) in order to determine the height adjustment of the feed channel.

3. The combine harvester of claim 2, wherein the control unit is configured to determine a height adjustment of the feed channel when lifting the draper by:
access a threshold value for a pivot angle;
compare the pivot angle with the threshold value; and
responsive to determining that the pivot angle equals or exceeds the threshold value for the pivot angle, controlling the side segments into a deflected position in which the side segments are swiveled up at a predetermined angle relative to the center segment.

4. The combine harvester of claim 3, wherein the predetermined angle comprises a maximum assumable angle.

5. The combine harvester of claim 3, further comprising a sensor arrangement positioned on each of the frame joints at least two side segments and configured to monitor an angle arising between the center segment and each of the at least two side segments.

6. The combine harvester of claim 2, wherein the control unit is further configured to receive an indication of a manually-initiated lifting of the draper; and
wherein, responsive to the control unit determining receipt of the indication of a manually-initiated lifting of the draper, the control unit is configured to actuate the one or more actuators depending on the height adjustment of the feed channel.

7. The combine harvester of claim 1, wherein the control unit is further configured to receive an indication of operating in an automatic mode; and
wherein the control unit is configured to control the at least two side segments in the automatic mode based on at least a first target value for a first operation of the combine harvester and a second target value for a second operation of the combine harvester, wherein the second target value is greater than the first target value;
wherein, responsive to determining the combine harvester is operating in the first operation, the control unit is configured to control, based on the first target value, a position of the draper or a pivot angle of the feed channel; and
wherein, responsive to determining the combine harvester is operating in the second operation, the control unit is configured to control, based on the second target value, the position of the draper or the pivot angle of the feed channel.

8. The combine harvester of claim 7, wherein the first operation of the combine harvester comprises picking up harvested material by the draper; and
wherein the second operation of the combine harvester comprises one or both of reaching or driving a headland.

9. The combine harvester of claim 8, wherein the control unit is further configured to:
receive a manual input indicative of an override; and
responsive to receiving the override, override the automatic mode when operating in one or both of the first operation or the second operation.

10. The combine harvester of claim 8, wherein the control unit is further configured to:
receive an indication of a manual input indicative of an override; and
responsive to receiving the override, override the automatic mode when operating in both the first operation and the second operation.

11. A method for operating a self-propelled combine harvester, the method comprising:
using the combine harvester, the combine harvester comprising a feed channel and a draper, the feed channel being pivotably articulated to the combine harvester about a horizontal axis for height adjustment, the draper positioned on the feed channel and including a center segment with a central frame segment and at least two side segments, each with an outer frame segment, wherein a respective side segment is pivotably connected to the center segment by a frame joint comprising a pivot axis, wherein the respective side segment is positionable relative to the center segment by one or more actuators;
automatically determining a height adjustment of the feed channel when lifting the draper; and
automatically actuate the one or more actuators in order to align the at least two side segments relative to the center segment depending on the height adjustment of the feed channel when lifting the draper.

12. The method of claim 11, further comprising:
generating, by at least one sensor, one or more signals indicative of a pivot angle of the feed channel; and
transmitting the one or more signals to a control unit; and
wherein the control unit automatically determines the height adjustment of the feed channel based on the one or more signals.

13. The method of claim 12, wherein the control unit compares the pivot angle with a threshold value; and
wherein the control unit controls the at least two side segments to transfer into a deflected position in which the at least two side segments are swiveled up at a predetermined angle relative to the center segment.

14. The method of claim 13, wherein the predetermined angle comprises a maximum assumable angle.

15. The method of claim 14, further comprising:
performing a manually-initiated lifting of the draper;
determining whether the pivot angle meets or exceeds the threshold value; and
responsive to the pivot angle meeting or exceeding the threshold value, automatically interrupting the manually-initiated lifting of the draper.

16. The method of claim 15, further comprising, responsive to the pivot angle meeting or exceeding the threshold value, automatically deflecting the at least two side segments.

17. The method of claim 11, wherein the one or more actuators are actuated depending on the height adjustment of the feed channel only when there is manually-initiated lifting of the draper.

18. The method of claim 11, further comprising receiving an indication of operating in an automatic mode; and
wherein a control unit controls the at least two side segments in the automatic mode based on at least a first target value for a first operation of the combine harvester and a second target value for a second operation of the combine harvester, wherein the second target value is greater than the first target value;
wherein, responsive to determining the combine harvester is operating in the first operation, the control unit controls, based on the first target value, a position of the draper or a pivot angle of the feed channel; and
wherein, responsive to determining the combine harvester is operating in the second operation, the control unit controls, based on the second target value, the position of the draper or the pivot angle of the feed channel.

19. The method of claim 18, wherein the first operation of the combine harvester comprises picking up harvested material by the draper; and
wherein the second operation of the combine harvester comprises one or both of reaching or driving a headland.

20. The method of claim 19, wherein the control unit further:
receives a manual input indicative of an override; and
responsive to receiving the override, overrides the automatic mode when operating in one or both of the first operation or the second operation.
